(19) United States
(12) Patent Application Publication
(10) Pub. No.: US 2025/0132115 A1
(43) Pub. Date: Apr. 24, 2025

(54) ELECTROMAGNETIC RELAY

(71) Applicant: OMRON Corporation, Kyoto-shi (JP)

(72) Inventors: Masaki SUGIHARA, Kyoto-shi (JP); Masayuki NODA, Kyoto-shi (JP); Hitoshi HAYASHI, Kyoto-shi (JP)

(21) Appl. No.: 18/907,599

(22) Filed: Oct. 7, 2024

(30) Foreign Application Priority Data
Oct. 18, 2023 (JP) 2023-179439

(51) Int. Cl. H01H 50/14; H01H 50/02; H01H 50/44

(52) U.S. Cl. CPC H01H 50/14; H01H 50/02; H01H 50/443

(57) ABSTRACT

An electromagnetic relay includes a base, a first contact terminal, a second contact terminal, and a case. The first contact terminal and the second contact terminal protrude downward from the base. The first contact terminal includes a first bent portion. The second contact terminal includes a second bent portion. The first bent portion and the second bent portion are disposed on the bottom surface of the base on a first side of the center line of the base and bent along the bottom surface of the base. The case or the base includes a stand portion. The stand portion protrudes downward. The stand portion is disposed on a second side opposite the first side with respect to the center line of the base.

### FIELD

The claimed invention relates to an electromagnetic relay.

### BACKGROUND

Among the electromagnetic relays, there is a so-called surface mount-type. For example, as disclosed in Japan patent application publication No. 2016-201306, in a surface mount-type electromagnetic relay, a terminal protrudes downward from a base and has a bent portion that is bent laterally. The bent portion is soldered to a circuit board, thereby mounting the electromagnetic relay on the circuit board.

One method for mounting an electromagnetic relay on a circuit board is reflow soldering. In reflow soldering, solder is applied to the circuit board in advance, and the electromagnetic relay is then placed on the solder. The solder is then heated in a reflow furnace, thereby soldering the electromagnetic relay to the circuit board. By using such reflow soldering, the electromagnetic relay can be efficiently mounted on the circuit board.

However, in the above-mentioned surface mount type electromagnetic relay, depending on the arrangement of the terminals, the balance when placed on the circuit board may be poor, making it difficult to mount it on the circuit board. For example, if the terminals are arranged asymmetrically on the bottom surface of the base, the electromagnetic relay may not be able to maintain its posture when placed on a circuit board and may tilt. In that case, mounting by reflow soldering as described above is difficult. Alternatively, the electromagnetic relay may be placed unstably, which may reduce the accuracy of its mounting on the circuit board.

An object of the claimed invention is to provide an electromagnetic relay that can be stably mounted on a circuit board even if the terminals are arranged in a way that makes the posture of the electromagnetic relay on the circuit board unstable. An embodiment of an electromagnetic relay in accordance with the claimed invention includes a base, a first contact terminal, a second contact terminal, and a case. The first contact terminal protrudes downward from the base. The first contact terminal includes a first bent portion. The first bent portion is disposed on a first side of a center line of a bottom surface of the base as seen in a bottom view of the electromagnetic relay. The first bent portion is bent along the bottom surface of the base. The second contact terminal projects downward from the base. The second contact terminal includes a second bent portion. The second bent portion is disposed on the first side of the center line as seen in the bottom view. The second bent portion is bent along the bottom surface of the base. The case is attached to the base and covers the base. The case or the base includes a stand portion. The stand portion projects downward from the case or the base. The stand portion is disposed on a second side opposite the first side with respect to the center line of the base.

In the electromagnetic relay of the embodiment, the stand portion prevents the electromagnetic relay from tilting when placed on a circuit board. Therefore, the posture of the electromagnetic relay before soldering can be stably maintained on the circuit board. This allows the electromagnetic relay to be stably mounted on the circuit board.

The lower end of the stand portion may be disposed flush with (i.e., even with or at the same level as) the first bent portion and the second bent portion. In this case, the stand portion can keep the electromagnetic relay in a more stable posture on the circuit board before soldering.

The electromagnetic relay may further include a first coil terminal and a second coil terminal. The first coil terminal may protrude downward from the base. The first coil terminal may include a third bent portion bent along the bottom surface of the base. The second coil terminal may protrude downward from the base. The second coil terminal may include a fourth bent portion bent along the bottom surface of the base. The third bent portion may be located on the bottom surface of the base, on the first side of the center line. The fourth bent portion may be located on the bottom surface of the base, on the second side of the center line. Alternatively, the third bent portion and the fourth bent portion may be located on the bottom surface of the base, on the first side of the center line. In this way, even if the terminals are arranged in a way that makes the electromagnetic relay unstable, the stand portion can keep the electromagnetic relay in a stable posture on the circuit board.

The lower end of the stand portion may be disposed flush with (i.e., even with or at the same level as) the third bent portion and the fourth bent portion. In this case, the stand portion can keep the electromagnetic relay in a more stable posture on the circuit board before soldering. The stand may be provided on the case. The stand may be provided on the base.

An another embodiment of an electromagnetic relay in accordance with the claimed invention includes a base, a first contact terminal, a second contact terminal, a first coil terminal, a second coil terminal, and a case. The first contact terminal protrudes downward from the base. The first contact terminal includes a first bent portion. The first bent portion is bent along the bottom surface of the base. The second contact terminal projects downward from the base. The second contact terminal includes a second bent portion. The second bent portion is bent along the bottom surface of the base. The first coil terminal protrudes downward from the base. The first coil terminal includes a third bent portion. The third bent portion is bent along the bottom surface of the base. The second coil terminal protrudes downward from the base. The second coil terminal includes a fourth bent portion. The fourth bent portion is bent along the bottom surface of the base. The case is attached to the base and covers the base.

The base and the case include a first area, a second area, a third area, and a fourth area as seen in the bottom view. The second area is disposed symmetrically with the first area with respect to a first center line. The third area is disposed symmetrically with the first area with respect to a second center line perpendicular to the first center line. The fourth area is disposed symmetrically with the second area with respect to the second center line. The first bent portion, the second bent portion, the third bent portion, and the fourth bent portion are each disposed in one or more areas of the first area, the second area, the third area, and the fourth area except for at least one of them. The case or the base includes a stand portion that projects downward from the case or the base. The stand portion is arranged in an area among the first area, the second area, the third area, and the fourth area where the first bent portion, the second bent portion, the third bent portion, and the fourth bent portion are not arranged.

In the electromagnetic relay according to the disclosed embodiment, the stand portion prevents the electromagnetic relay from tilting when placed on a circuit board. Therefore, the posture of the electromagnetic relay before soldering can be stably maintained on the circuit board. This allows the electromagnetic relay to be stably mounted on the circuit board.

The lower end of the stand portion may be disposed flush with (i.e., at the same level as or even with) the first bent portion, the second bent portion, the third bent portion, and the fourth bent portion. In this case, the stand portion can keep the electromagnetic relay in a more stable posture on the circuit board before soldering.

The first bent portion and the second bent portion may be disposed in the first area. The third bent portion may be disposed in the third area. The fourth bent portion may be disposed in the fourth area. The stand portion may be disposed in the second area. In this way, even if the terminals are arranged in a way that makes the electromagnetic relay unstable, the stand portion can keep the electromagnetic relay in a stable posture on the circuit board. The stand may be provided on the case. The stand may be provided on the base.

### BRIEF DESCRIPTION OF THE DRAWINGS

FIG. 1 is a perspective view of an embodiment of an electromagnetic relay in accordance with the claimed invention.

FIG. 2 is a perspective view of the electromagnetic relay from below.

FIG. 3 is a bottom view of the electromagnetic relay.

FIG. 4 is a side view of the electromagnetic relay.

FIG. 5 is a front view of the electromagnetic relay.

FIG. 6 is a side view of a relay body with the case omitted.

FIG. 7 is a side view of the relay body with the case omitted.

FIG. 8 is a perspective view of the case from below.

FIG. 9 is a bottom view of an electromagnetic relay of a first modified embodiment.

FIG. 10 is a bottom view of an electromagnetic relay of a second modified embodiment.

FIG. 11 is a bottom view of an electromagnetic relay of a third modified embodiment.

FIG. 12 is a bottom view of an electromagnetic relay of a fourth modified embodiment.

### DETAILED DESCRIPTION

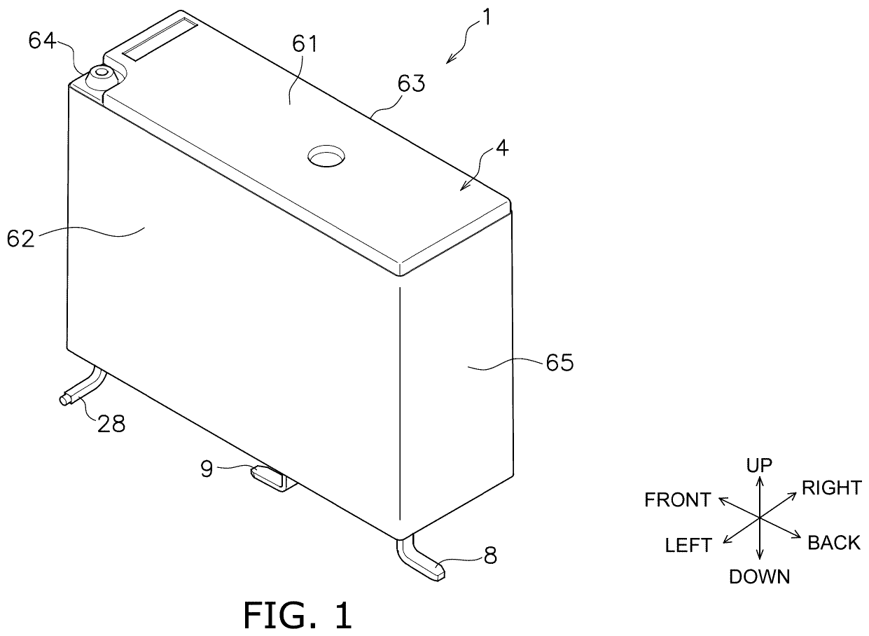

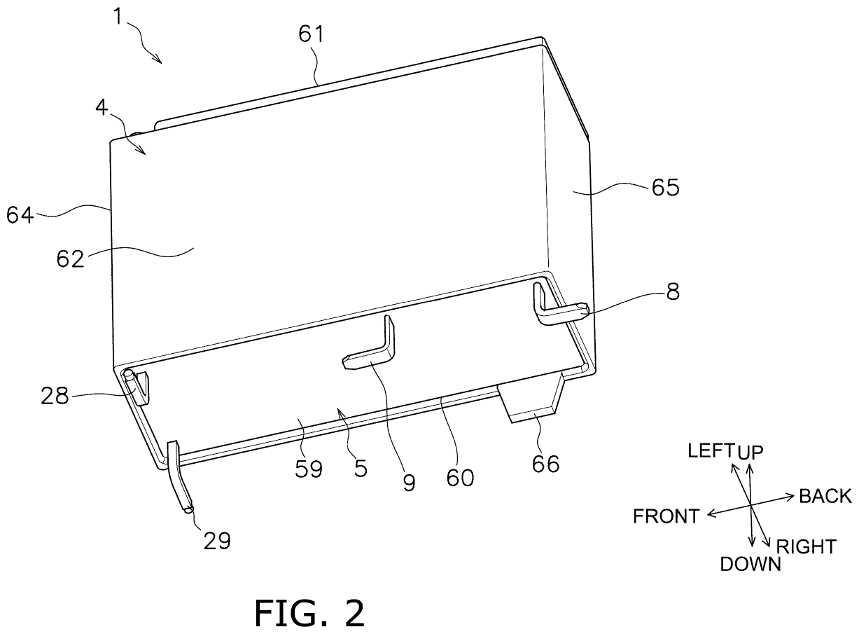

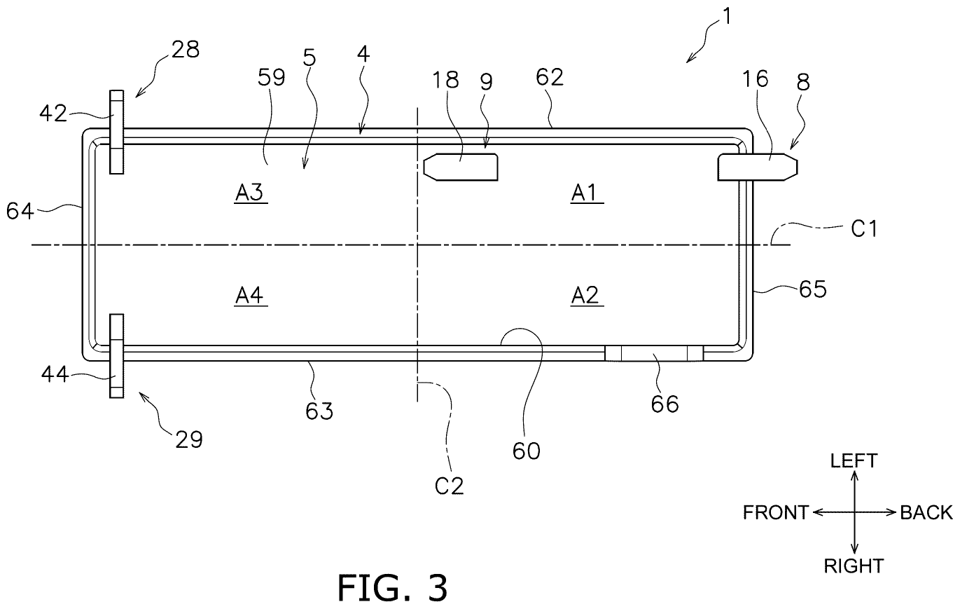

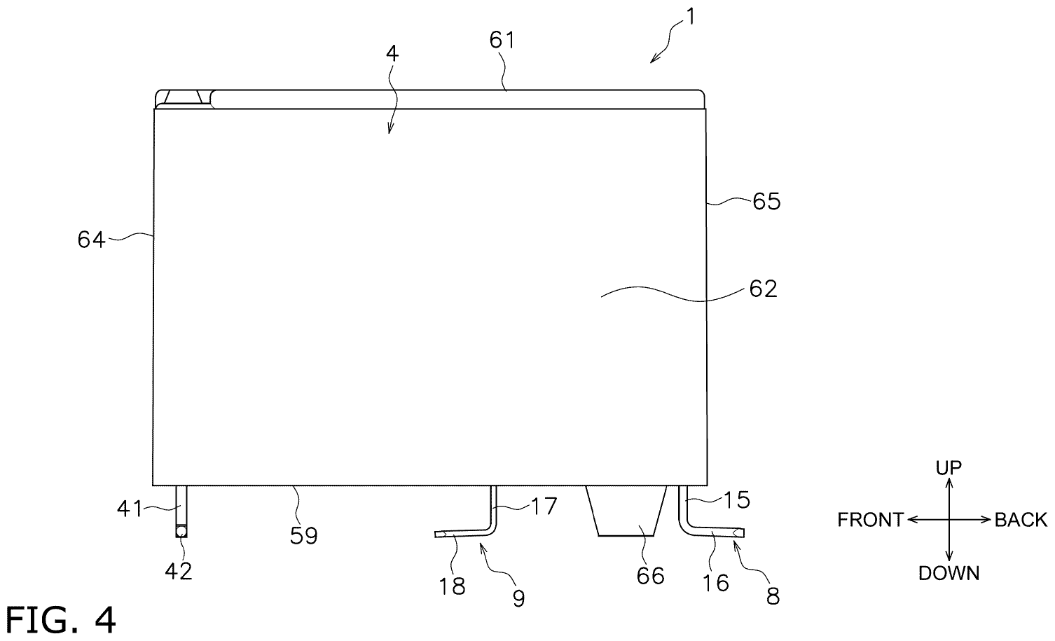

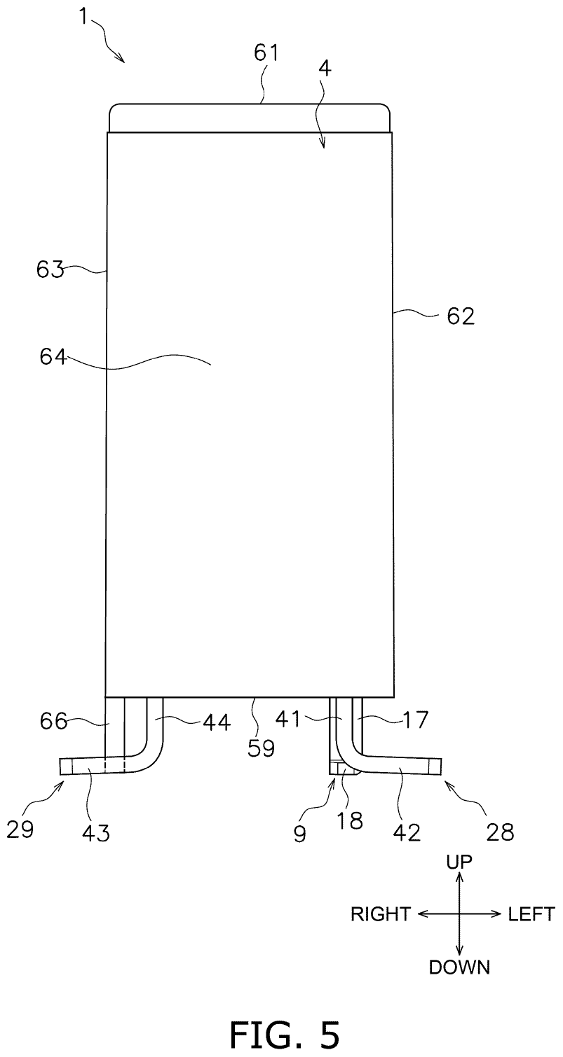

Hereinafter, an embodiment of an electromagnetic relay in accordance with the claimed invention will be described with reference to the drawings. FIGS. 1 and 2 are perspective views of an electromagnetic relay 1. FIG. 3 is a bottom view of the electromagnetic relay 1. FIG. 4 is a side view of the electromagnetic relay 1. FIG. 5 is a front view of the electromagnetic relay 1. The electromagnetic relay 1 is a surface-mount type relay. As shown in FIGS. 1 to 5, the electromagnetic relay 1 includes a case 4.

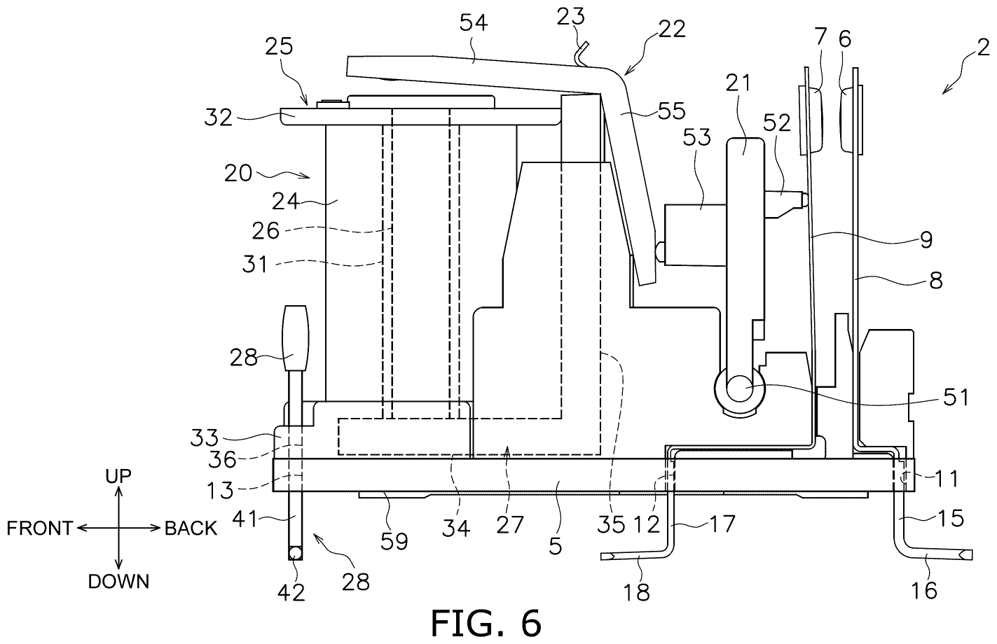

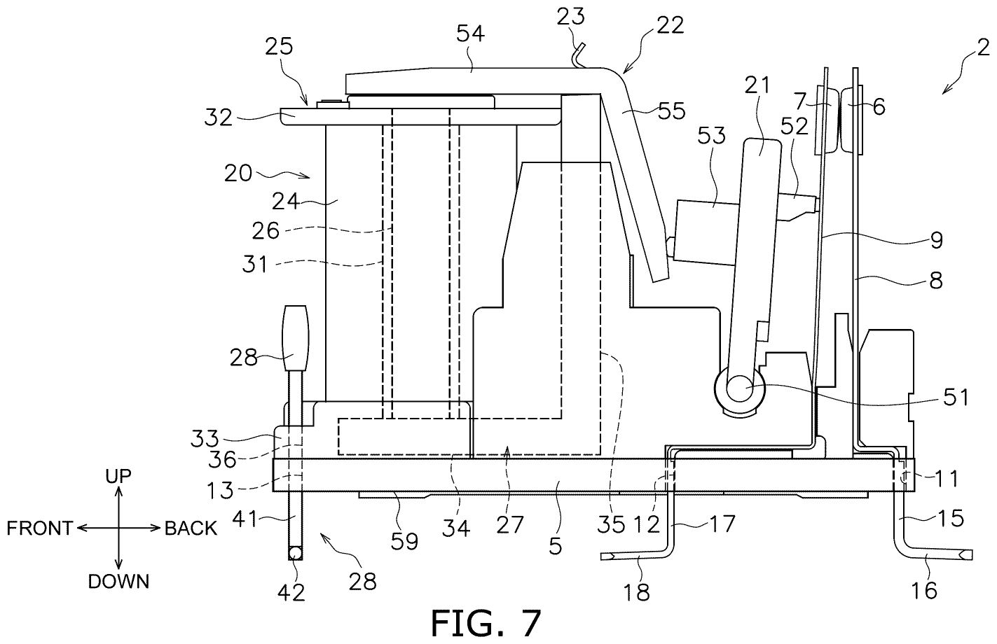

FIGS. 6 and 7 are side views of the electromagnetic relay 1 with the case 4 omitted. As shown in FIGS. 6 and 7, the electromagnetic relay 1 includes a base 5, a fixed contact 6, a movable contact 7, a first contact terminal 8, and a second contact terminal 9.

In the following description, the direction in which the fixed contact 6 and the movable contact 7 are arranged with respect to the base 5 is defined as the upper side, and the opposite direction is defined as the lower side. The direction in which the movable contact 7 is disposed relative to the fixed contact 6 is defined as the front, and the opposite direction is defined as the rear. The left and right sides facing forward are defined as the left and right sides, respectively. However, these directions are used for convenience of explanation and do not limit the arrangement of the electromagnetic relay 1.

The fixed contact 6 and the movable contact 7 are made of a conductive metal. The fixed contact 6 and the movable contact 7 are disposed above the base 5. The movable contact 7 is disposed to face the fixed contact 6. The fixed contact 6 is connected to the first contact terminal 8. The movable contact 7 is connected to the second contact terminal 9. The first contact terminal 8 and the second contact terminal 9 are made of a conductive metal. The second contact terminal 9 is disposed to face the first contact terminal 8. The first contact terminal 8 and the second contact terminal 9 are supported by the base 5. The base 5 is made, for example, of resin. The first contact terminal 8 and the second contact terminal 9 extend upward from the base 5. The first contact terminal 8 and the second contact terminal 9 protrude downward from the base 5 to the outside of the electromagnetic relay 1.

The base 5 includes a first base hole 11 and a second base hole 12. The first contact terminal 8 is press-fitted into the first base hole 11. The first contact terminal 8 protrudes below the base 5 through the first base hole 11. The second contact terminal 9 is press-fitted into the second base hole 12. The second contact terminal 9 protrudes below the base 5 through the second base hole 12.

The first contact terminal 8 includes a first straight portion 15 and a first bent portion 16. The first straight portion 15 extends downward from the base 5 through the first base hole 11. The first bent portion 16 is bent with respect to the first straight portion 15. The first bent portion 16 extends rearward from the first straight portion 15. The second contact terminal 9 includes a second straight portion 17 and a second bent portion 18. The second straight portion 17 extends downward from the base 5 through the second base hole 12. The second bent portion 18 is bent with respect to the second straight portion 17. The second bent portion 18 extends forward from the second straight portion 17.

As shown in FIG. 6, the electromagnetic relay 1 includes a coil block 20, a card 21, an armature 22, and a return spring 23. The coil block 20 generates an electromagnetic force that moves the movable contact 7 between an open position and a closed position. As shown in FIG. 6, when the movable contact 7 is at the open position, the movable contact 7 is separated from the fixed contact 6. As shown in FIG. 7, when the movable contact 7 is at the closed position, the movable contact 7 is in contact with the fixed contact 6. The coil block 20 includes a coil 24, a spool 25, an iron core 26, a yoke 27, a first coil terminal 28, and a second coil terminal 29.

The coil 24 is wound around the spool 25. Although not shown in the figure, the ends of the coil 24 are connected to the first coil terminal 28 and the second coil terminal 29, respectively. The spool 25 is supported by the base 5. The spool 25 includes a cylindrical portion 31, an upper flange 32, and a lower flange 33. The coil 24 is wound around the cylindrical portion 31. The upper flange 32 and the lower flange 33 protrude radially from the cylindrical portion 31. The upper flange 32 is disposed above the cylindrical portion 31. The lower flange 33 is disposed below the cylindrical portion 31.

The iron core 26 is disposed within the spool 25. The yoke 27 has an L-shaped bent shape. The yoke 27 includes a first yoke portion 34 and a second yoke portion 35. The yoke 27 is bent between the first yoke portion 34 and the second yoke portion 35. The first yoke portion 34 is disposed below the iron core 26. The first yoke portion 34 is connected to the iron core 26. The second yoke portion 35 extends upward from the first yoke portion 34.

The first coil terminal 28 and the second coil terminal 29 are supported by the spool 25 and the base 5. The first coil terminal 28 and the second coil terminal 29 extend upward from the spool 25. The first coil terminal 28 and the second coil terminal 29 protrude downward from the base 5 to the outside of the electromagnetic relay 1.

The spool 25 includes a first spool hole 36. The first spool hole 36 is provided in the lower flange 33. The base 5 includes a third base hole 13. The first coil terminal 28 is press-fitted into the first spool hole 36. Alternatively, the first coil terminal 28 may be press-fitted into the third base hole 13. The first coil terminal 28 protrudes below the base 5 through the first spool hole 36 and the third base hole 13. Although not shown, the spool 25 includes a second spool hole similar to the first spool hole 36. The base 5 includes a fourth base hole similar to the third base hole 13. The second coil terminal 29 protrudes below the base 5 through the second spool hole and the fourth base hole.

The first coil terminal 28 includes a third straight portion 41 and a third bent portion 42. The third straight portion 41 extends downward from the base 5. The third bent portion 42 is bent with respect to the third straight portion 41. The third bent portion 42 extends leftward from the third straight portion 41. The second coil terminal 29 includes a fourth straight portion 43 and a fourth bent portion 44. The fourth straight portion 43 extends downward from the base 5. The fourth bent portion 44 is bent with respect to the fourth straight portion 43. The fourth bent portion 44 extends rightward from the fourth straight portion 43.

As shown in FIG. 6, the card 21 includes a rotation axis 51, a pressing portion 52, and a receiving portion 53. The rotation axis 51 is rotatably supported by the base 5. The pressing portion 52 is disposed to face the second contact terminal 9. The receiving portion 53 is disposed to face the armature 22.

The armature 22 includes a first armature portion 54 and a second armature portion 55. The armature 22 has a bent shape between the first armature portion 54 and the second armature portion 55. The first armature portion 54 is disposed above the iron core 26. The first armature portion 54 is disposed to face the iron core 26. The second armature portion 55 extends downward from the first armature portion 54. The second armature portion 55 is disposed to face the receiving portion 53 of the card 21.

The armature 22 is supported by the second yoke portion 35. The armature 22 is supported rotatably around the upper end of the second yoke portion 35. The return spring 23 is connected to the armature 22. The return spring 23 may be, for example, a hinge spring. The return spring 23 biases the armature 22 in a direction in which the second armature portion 55 moves away from the receiving portion 53 of the card 21.

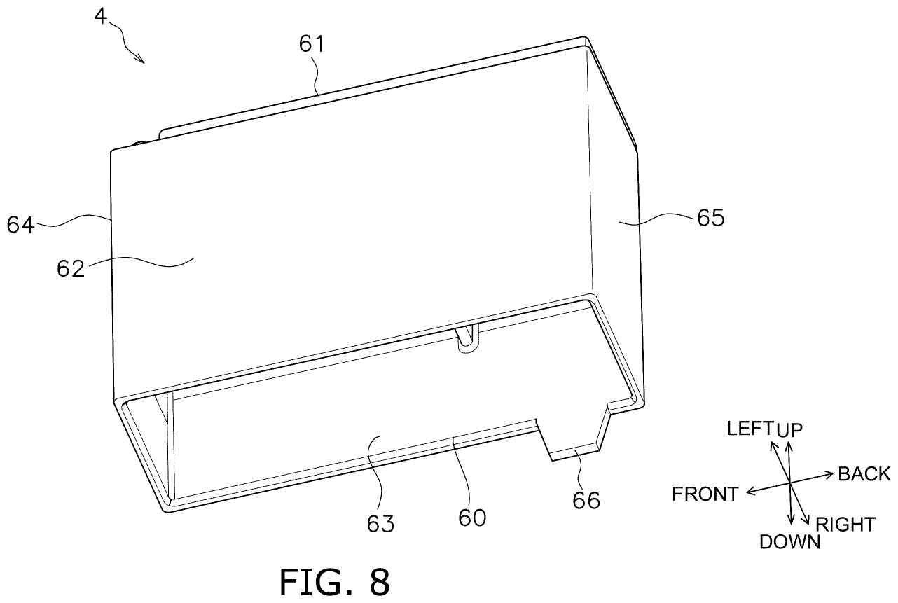

FIG. 8 is a perspective view of the case 4. As shown in FIG. 8, the case 4 has a box shape including an opening 60 that opens downward. The case 4 is a separate body from the base 5. The base 5 is disposed in the opening 60. The case 4 covers the base 5 from above. The case 4 is attached to the base 5 and covers the fixed contact 6, the movable contact 7, the coil block 20, the card 21, the armature 22, and the return spring 23. The case 4 includes a top surface 61, a first side surface 62, a second side surface 63, a third side surface 64, and a fourth side surface 65.

The top surface 61 is disposed above the base 5. The first side surface 62, the second side surface 63, the third side surface 64, and the fourth side surface 65 extend downward from the top surface 61. The first side surface 62 is disposed on the left side of the base 5. The second side surface 63 is disposed on the right side of the base 5. The third side surface 64 is disposed in front of the base 5. The fourth side surface 65 is disposed behind the base 5. The lower ends of the first side surface 62, the second side surface 63, the third side surface 64, and the fourth side surface 65 are disposed flush with the bottom surface 59 of the base 5. In addition, the lower ends of each of the first side surface 62, the second side surface 63, the third side surface 64, and the fourth side surface 65 may be located at a height different from the bottom surface 59 of the base 5.

Next, the operation of the electromagnetic relay 1 will be described. In the following description, the direction in which the movable contact 7 approaches the fixed contact 6 is defined as the closing direction, and the direction in which the movable contact 7 moves away from the fixed contact 6 is defined as the opening direction. When no current flows through the coil 24, the movable contact 7 is separated from the fixed contact 6 as shown in FIG. 6.

When a current flows through the coil 24, the first armature portion 54 is attracted to the iron core 26 by an electromagnetic force generated by the coil 24. As a result, the armature 22 rotates against the biasing force of the return spring 23. When the armature 22 rotates, the second armature portion 55 presses the receiving portion 53 of the card 21 in the closing direction. As a result, the card 21 rotates in the closing direction, causing the pressing portion 52 of the card 21 to press the second contact terminal 9 in the closing direction. The second contact terminal 9 is elastically deformed when pressed by the pressing portion 52, whereby the movable contact 7 moves in the closing direction and contacts the fixed contact 6 as shown in FIG. 7.

When the current to the coil 24 is cut off, the electromagnetic force by which the iron core 26 attracts the first armature portion 54 disappears. Therefore, the armature 22 rotates in the opposite direction to the above-mentioned direction due to the biasing force of the return spring 23. As a result, the card 21 rotates in the opening direction, and the second contact terminal 9 moves in the opening direction due to the elastic force of the second contact terminal 9. As a result, the movable contact 7 moves in the opening direction and separates from the fixed contact 6.

Next, the arrangement of the first contact terminal 8, the second contact terminal 9, the first coil terminal 28, and the second coil terminal 29 will be described. As shown in FIGS. 4 and 5, the first straight portion 15 of the first contact terminal 8 extends downward from the base 5. The first bent portion 16 of the first contact terminal 8 is bent along the bottom surface 59 of the base 5. The second straight portion 17 of the second contact terminal 9 extends downward from the base 5. The second bent portion 18 of the second contact terminal 9 is bent along the bottom surface 59 of the base 5.

The third straight portion 41 of the first coil terminal 28 extends downward from the base 5. The third bent portion 42 of the first coil terminal 28 is bent along the bottom surface 59 of the base 5. The fourth straight portion 43 of the second coil terminal 29 extends downward from the base 5. The fourth bent portion 44 of the second coil terminal 29 is bent along the bottom surface 59 of the base 5. The first bent portion 16, the second bent portion 18, the third bent portion 42, and the fourth bent portion 44 are disposed flush with one another (i.e., at the same level as or even with each other).

As shown in FIG. 3, the first bent portion 16 of the first contact terminal 8 and the second bent portion 18 of the second contact terminal 9 are disposed asymmetrically on the bottom surface 59 of the base 5. In particular, the first bent portion 16 and the second bent portion 18 are disposed asymmetrically with respect to the center line of the bottom surface 59 of the base 5 as seen in the bottom view. The center line of the bottom surface 59 of the base 5 includes a first center line C1 and a second center line C2. The first center line C1 extends in the longitudinal direction of the bottom surface 59 of the base 5. In this embodiment, the longitudinal direction of the bottom surface 59 of the base 5 is the front-rear direction. The second center line C2 is perpendicular to the first center line C1. That is, the second center line C2 extends in the left-right direction.

The first bent portion 16 and the second bent portion 18 are disposed on the bottom surface 59 of the base 5 on a left side of the first center line C1 as seen in the bottom view. The first bent portion 16 and the second bent portion 18 are disposed rearward of the second center line C2 on the bottom surface 59 of the base 5 as seen in the bottom view. The third bent portion 42 is disposed on the bottom surface 59 of the base 5 on the left side of the first center line C1 as seen in the bottom view. The fourth bent portion 44 is disposed on the bottom surface 59 of the base 5 on a right side of the first center line C1 as seen in the bottom view. The third bent portion 42 and the fourth bent portion 44 are disposed forward of the second center line C2 on the bottom surface 59 of the base 5 as seen in the bottom view.

The case 4 and the bottom surface 59 of the base 5 include a first area A1, a second area A2, a third area A3, and a fourth area A4. The second area A2 is disposed symmetrically with the first area A1 with respect to the first center line C1. The third area A3 is disposed symmetrically with the first area A1 with respect to the second center line C2. The fourth area A4 is disposed symmetrically with the second area A2 with respect to the second center line C2. The fourth area A4 is disposed symmetrically with the third area A3 with respect to the first center line C1.

The first bent portion 16 of the first contact terminal 8 and the second bent portion 18 of the second contact terminal 9 are disposed in the first area A1. The third bent portion 42 of the first coil terminal 28 is disposed in the third area A3. The fourth bent portion 44 of the second coil terminal 29 is disposed in the fourth area A4.

With the asymmetrical arrangement of the first contact terminal 8, the second contact terminal 9, the first coil terminal 28, and the second coil terminal 29 as described above, the posture of the electromagnetic relay 1 when placed on a circuit board is likely to become unstable. Therefore, in the electromagnetic relay 1 of this embodiment, the case 4 includes a stand portion 66 in order to stabilize the posture of the electromagnetic relay 1 when placed on a circuit board.

The stand portion 66 protrudes downward from the lower end of the case 4. The stand portion 66 protrudes downward from the lower end of the second side surface 63. The lower end of the stand portion 66 has a flat shape. The lower end of the stand portion 66 is disposed flush with (i.e., at the same level as) the first bent portion 16, the second bent portion 18, the third bent portion 42, and the fourth bent portion 44.

The stand portion 66 is disposed on the opposite side of the first bent portion 16 and the second bent portion 18 with respect to the first center line C1 as seen in the bottom view. That is, the stand portion 66 is disposed on the right side of the first center line C1 as seen in the bottom view. The stand portion 66 is disposed in an area of the first to fourth areas A1 to A4 where the first to fourth bent portions 16, 18, 42, and 44 are not disposed. That is, the stand portion 66 is disposed in the second area A2.

In the electromagnetic relay 1 according to the disclosed embodiment described above, the stand portion 66 prevents the electromagnetic relay 1 from tilting when placed on a circuit board. Therefore, the posture of the electromagnetic relay 1 before soldering can be stably maintained on the circuit board. This allows the electromagnetic relay 1 to be stably mounted on the circuit board.

Although one embodiment of the claimed invention has been described above, the claimed invention is not limited to the above embodiment, and various modifications are possible without departing from the scope of the invention.

The structure of the base 5 is not limited to that in the above embodiment and may be modified. The structures of the fixed contact 6, the movable contact 7, the first contact terminal 8, and the second contact terminal 9 are not limited to those in the above embodiment, and may be modified. For example, the fixed contact 6 may be a separate body from the first contact terminal 8 or may be integrated with the first contact terminal 8. The movable contact 7 may be a separate body from the second contact terminal 9 or may be integrated with the second contact terminal 9. The fixed contact 6 may be connected to the second contact terminal 9. The movable contact 7 may be connected to the first contact terminal 8.

The structures of the coil block 20, the card 21, the armature 22, and the return spring 23 are not limited to those in the above embodiment, and may be modified. For example, the card 21 may be movable linearly. The structure of the case 4 is not limited to that in the above embodiment and may be modified. For example, multiple stand portions may be provided on the case 4.

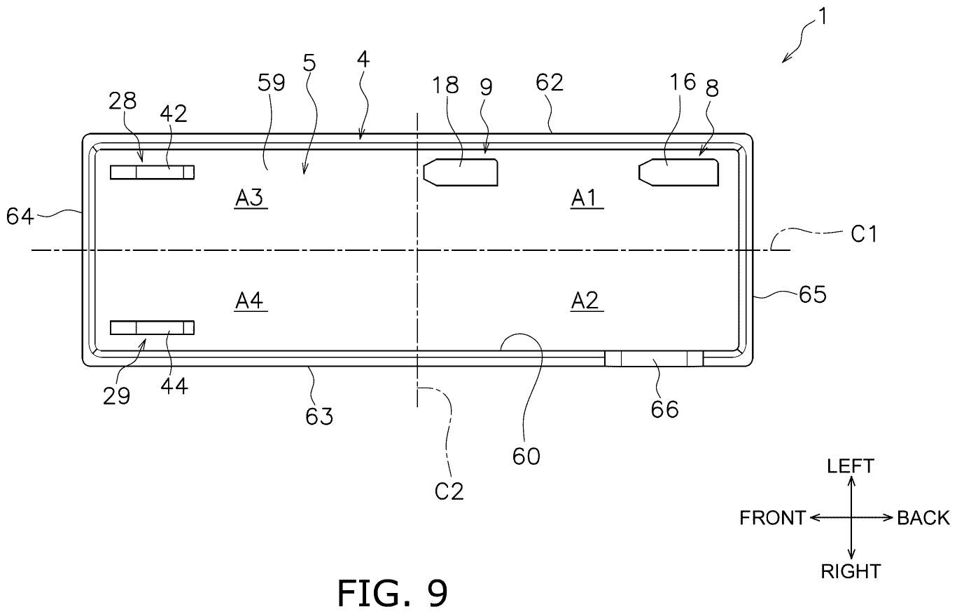

The bending directions of the first to fourth bent portions 16, 18, 42, and 44 are not limited to those in the above embodiment and may be changed. For example, FIG. 9 is a bottom view of the electromagnetic relay 1 of the first modified embodiment. As shown in FIG. 9, the first to fourth bent portions 16, 18, 42, and 44 may be bent toward the inside of the bottom surface 59 of the base 5 so as not to protrude outward from the bottom surface 59 of the base 5. The first bent portion 16 and the second bent portion 18 may be bent in the same direction. The third bent portion 42 and the fourth bent portion 44 may be bent in the same direction. The first bent portion 16 and the second bent portion 18 may be bent not only in the front-rear direction but also in the left-right direction. The third bent portion 42 and the fourth bent portion 44 may be bent in the front-rear direction instead of the left-right direction. The first bent portion 16 and the second bent portion 18 may be bent in directions facing each other. The third bent portion 42 and the fourth bent portion 44 may be bent in directions facing each other.

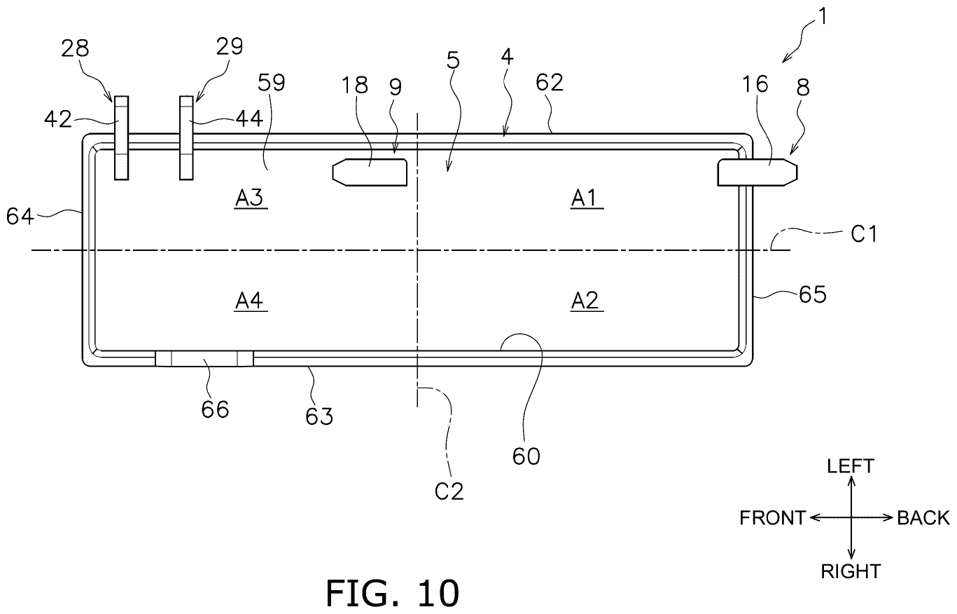

The arrangement of the first to fourth bent portions 16, 18, 42, and 44 and the stand portion 66 is not limited to that in the above embodiment and may be changed. For example, FIG. 10 is a bottom view of the electromagnetic relay 1 of the second modified embodiment. As shown in FIG. 10, the first to fourth bent portions 16, 18, 42, and 44 may all be disposed on the same side with respect to the first center line C1. In this case, the stand portion 66 is disposed on the opposite side of the first to fourth bent portions 16, 18, 42, and 44 with respect to the first center line C1. For example, as shown in FIG. 10, the stand portion 66 may be disposed in the fourth area A4. Alternatively, similar to the above embodiment, the stand portion 66 may be disposed in the second area A2.

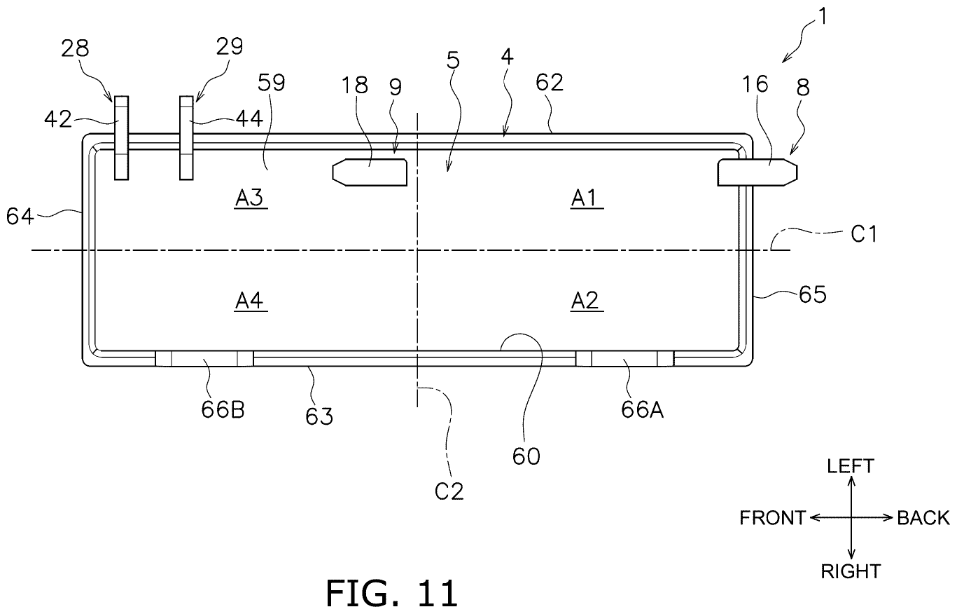

The number of stand portions is not limited to one, and multiple stand portions may be provided. For example, FIG. 11 is a bottom view of the electromagnetic relay 1 of the third modified embodiment. As shown in FIG. 11, the case 4 may include a plurality of stand portions 66A and 66B. The stand portion 66A may be disposed in the second area A2. The stand portion 66B may be disposed in the fourth area A4.

Alternatively, the first bent portion 16 and the second bent portion 18 may be disposed in the second area A2, and the stand portion 66 may be disposed in the first area A1. The third bent portion 42 and the fourth bent portion 44 may both be disposed in the third area A3, and the stand portion 66 may be disposed in the fourth area A4. Alternatively, conversely, the third bent portion 42 and the fourth bent portion 44 may both be disposed in the fourth area A4, and the stand portion 66 may be disposed in the third area A3.

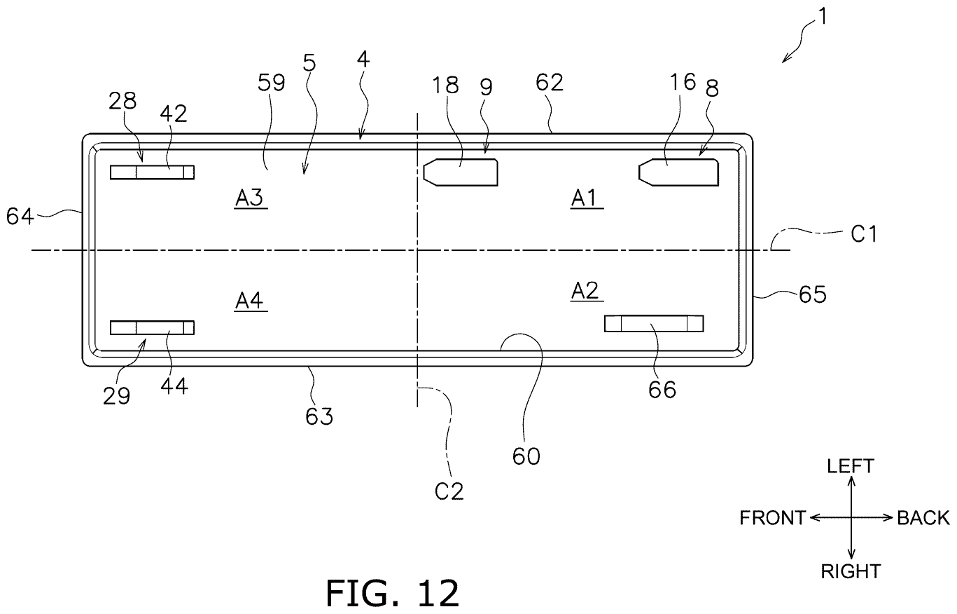

FIG. 12 is a bottom view of the electromagnetic relay 1 of the fourth modified embodiment. As shown in FIG. 12, the stand portion 66 may be provided on the base 5. The stand portion 66 may protrude downward from the bottom surface 59 of the base 5.

### REFERENCE SIGNS LIST

4: Case, 5: Base, 6: Fixed contact, 7: Movable contact, 8: First contact terminal, 9: Second contact terminal, 16: First bent portion, 18: Second bent portion, 28: First coil terminal, 29: Second coil terminal, 42: Third bent portion, 44: Fourth bent portion, 66: Stand portion, A1: First area, A2: Second area, A3: Third area, A4: Fourth area, C1: First center line, C2: Second center line

1. An electromagnetic relay, comprising:
a base including a bottom surface;
a first contact terminal protruding downward from the base, the first contact terminal including a first bent portion disposed on a first side of a center line of the bottom surface of the base as seen in a bottom view of the electromagnetic relay, the first bent portion being bent along the bottom surface of the base;
a second contact terminal protruding downward from the base, the second contact terminal including a second bent portion disposed on the first side of the center line as seen in the bottom view, the second bent portion being bent along the bottom surface of the base; and
a case attached to the base and covering the base,
the case or the base including a stand portion protruding downward, and
the stand portion being disposed on a second side opposite to the first side with respect to the center line of the base.

2. The electromagnetic relay according to claim 1, wherein a lower end of the stand portion is disposed flush or even with the first bent portion and the second bent portion.

3. The electromagnetic relay according to claim 1, further comprising:
a first coil terminal protruding downward from the base, the first coil terminal including a third bent portion bent along the bottom surface of the base; and
a second coil terminal protruding downward from the base, the second coil terminal including a fourth bent portion bent along the bottom surface of the base, wherein
the third bent portion is disposed on the first side of the center line as seen in the bottom view, and
the fourth bent portion is disposed on the second side of the center line as seen in the bottom view.

4. The electromagnetic relay according to claim 1, further comprising:
a first coil terminal protruding downward from the base, the first coil terminal including a third bent portion bent along the bottom surface of the base; and
a second coil terminal protruding downward from the base, the second coil terminal including a fourth bent portion bent along the bottom surface of the base,
wherein the third bent portion and the fourth bent portion are disposed on the first side of the center line as seen in the bottom view.

5. The electromagnetic relay according to claim 3, wherein a lower end of the stand portion is disposed flush or even with the third bent portion and the fourth bent portion.

6. The electromagnetic relay according to claim 1, wherein the stand portion is provided on the case.

7. The electromagnetic relay according to claim 1, wherein the stand portion is provided on the base.

8. An electromagnetic relay, comprising:
a base including a bottom surface;
a first contact terminal protruding downward from the base, the first contact terminal including a first bent portion bent along the bottom surface of the base;
a second contact terminal protruding downward from the base, the second contact terminal including a second bent portion bent along the bottom surface of the base;
a first coil terminal protruding downward from the base, the first coil terminal including a third bent portion bent along the bottom surface of the base;
a second coil terminal protruding downward from the base, the second coil terminal including a fourth bent portion bent along the bottom surface of the base; and
a case attached to the base and covering the base,
the base and the case, as seen in a bottom view of the electromagnetic relay, including
a first area,
a second area disposed symmetrically with the first area with respect to a first center line of the base,
a third area disposed symmetrically with the first area with respect to a second center line perpendicular to the first center line, and
a fourth area disposed symmetrically with the second area with respect to the second center line,
each of the first, second, third, and fourth bent portions being disposed in one of the first, second, third, and fourth areas,
the case or the base including a stand portion protruding downward, and
the stand portion being disposed in an area among the first, second, third, and fourth areas in which none of the first bent portion, the second bent portion, the third bent portion, and the fourth bent portion is disposed.

9. The electromagnetic relay according to claim 8, wherein a lower end of the stand portion is disposed flush or even with the first bent portion, the second bent portion, the third bent portion, and the fourth bent portion.

10. The electromagnetic relay according to claim 8, wherein
the first bent portion and the second bent portion are disposed in the first area,
the third bent portion is disposed in the third area,
the fourth bent portion is disposed in the fourth area, and
the stand portion is disposed in the second area.

11. The electromagnetic relay according to claim 8, wherein the stand portion is provided on the case.

12. The electromagnetic relay according to claim 8, wherein the stand portion is provided on the base.
